(19) United States
(12) Patent Application Publication
(10) Pub. No.: US 2009/0171756 A1
(43) Pub. Date: Jul. 2, 2009

(54) Modeling Responsible Consumer Balance Attrition Behavior

(76) Inventors: Shane De Zilwa, Oakland, CA (US); Jeffrey A. Feinstein, Roswell, GA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 11/966,798

(22) Filed: Dec. 28, 2007

(51) Int. Cl. G06Q 40/00; G06Q 10/00

(52) U.S. Cl. 705/10; 705/38

(57) ABSTRACT

A request to generate a balance attriter risk score that characterizes a likelihood of a change in a level of creditworthiness of an individual following balance attrition is received. Thereafter, one or more creditworthiness indicators such as future credit balance increases (a proxy for the responsibility of the individual) are estimated for the individual using a predictive model trained using historical creditworthiness data of a plurality of balance attriters. These estimated future balance increases are then associated with a balance attriter risk score so that such score can be provided. Related apparatus, systems, techniques, and articles are also described.

### RELATED APPLICATION

This application is related to U.S. patent application Ser. No. ______ (Attorney Docket No. 35006-535F01US), filed concurrently herewith on Dec. 28, 2007, the contents of which are hereby fully incorporated by reference.

### TECHNICAL FIELD

The subject matter described herein relates to systems and techniques for characterizing risk associated with payment card balance attrition.

### BACKGROUND

As consumers readily move their credit card balances between their credit cards as well as to other lines of credit (eg: installment loans, HELOCs), customer management retention efforts need to be sensitive to balance attriters who “churn” their balances between tradelines. At the time of balance attrition, or in the event of risk of balance attrition, lenders need to consider which balance attriters to allow to attrite and which to woo back (or prevent from balance attriting).

### SUMMARY

In one aspect, a request to generate a balance attriter risk score is received. The balance attriter risk score characterizes a likelihood of an change in a level of creditworthiness of credit line balance attriter based on responsible (or irresponsible) balance churn behavior following the consolidation event. Thereafter, creditworthiness indicators such as future balance changes (e.g., increases or decreases) and/or payment delinquencies for the credit line balance attriter are estimated using a predictive model trained using historical creditworthiness data of a plurality of balance attriters. The creditworthiness indicators are associated with a balance attriter risk score, the provision of which is later initiated (e.g., displayed, transmitted over a communications network such as the Internet, etc.).

The balance can be attrited to and/or from, for example, a home equity line of credit, a payment card such as a credit card, and the like. The historical creditworthiness data can be derived from masterfile data or from credit bureau data. The underlying model may utilize a wide variety of modeling technologies including, without limitation, a neural network model, a support vector machine, and the like. In addition, the request can be triggered based on a credit line balance decrease beyond a pre-defined level.

Articles are also described that comprise a machine-readable medium embodying instructions that when performed by one or more machines result in operations described herein. Similarly, computer systems are also described that may include a processor and a memory coupled to the processor. The memory may encode one or more programs that cause the processor to perform one or more of the operations described herein.

The subject matter described herein provides many advantages. For example, by allowing an identification of responsible and irresponsible balance attriters before loss exposure occurs, lenders can proactively evaluate risk, debt sensitivity, and revenue performance. For high risk balance attriters, pro-active measures may be taken such as exclusion or reduction of retention efforts and to limit subsequent line increases. In fact, in extreme cases, line reductions can be implemented immediately following balance attrition. Other measures such as reduction of authorization pads and of over limit allowances can be implemented. Furthermore, other protective measures such as reducing past due collection windows can be adopted (i.e., number of days for debt to be considered as past due can be reduced, etc.). On the other hand, measures (such as promotional pricing, increased reward and credit lines) can be taken to woo back balance attriters identified as low risk, or indeed similar measures can be taken prior to attrition to prevent them from balance attriting in the first place.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating a technique for predicting creditworthiness of an individual subsequent to balance attrition;

FIG. 2 is a graph illustrating balances over time for balance attriter accounts and all accounts;

FIG. 3 is a graph illustrating delinquent accounts as a function of behavior score, for balance attriter accounts and all accounts;

FIG. 4 is a graph illustrating balances over time as a function of the balance attriters' future performance;

FIG. 5 is a graph illustrating performance of the balance attriter risk score versus combination score in terms of identifying balance attriter performance; and

FIG. 6 is a diagram illustrating performance of the balance attriter risk score versus combination score in terms of identifying bad balances to lose.

### DETAILED DESCRIPTION

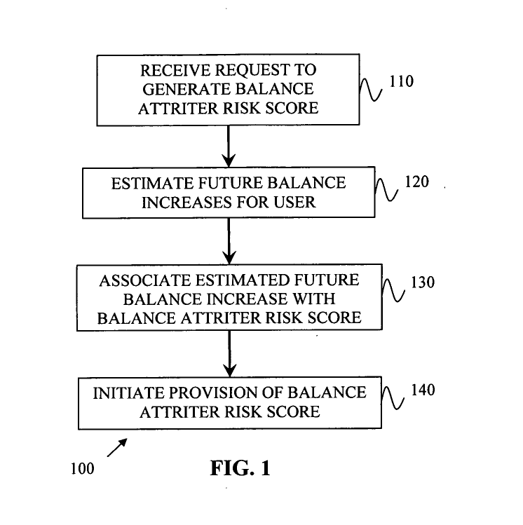

FIG. 1 is a process flow diagram illustrating a method 100, in which, at 110, a request to generate a balance attriter risk score is received. Such a request could occur, for example, immediately after balance attrition, or in the event that the risk of balance attrition is high. The balance attriter risk score characterizes a likelihood of a change in a level of creditworthiness of an individual following balance attrition. Thereafter, at 120, one or more creditworthiness indicators such as future credit balance increases and/or future payment delinquencies are estimated for the individual using a predictive model trained using historical creditworthiness data of a plurality of balance attriters. The creditworthiness indicators are associated, at 130, with a balance attriter risk score. Provision of the balance attriter risk score (whether by displaying the balance attriter risk score, transmitting the balance attriter risk score, etc.) is, at 140, initiated.

The models described herein were derived using an analysis of a single credit card masterfile data (i.e., merchant and/or payment card data characterizing a balance of a single user as opposed to aggregated data generated from a plurality of merchants) sample of “soon to balance attrite” consumers who would move their balances away from a payment card (mostly to another credit line) within three months after a credit scoring date. A broad definition of balance attrition was applied to include both full and partial balance attriters: $1000 reduction in revolving balance shortly after the scoring date. Other balance amounts that would reasonably indicate full or partial balance attrition can be used. Consumers' credit behaviors in the months subsequent to the balance attrition through a two year period were analyzed to identify unique strategic opportunities in managing these balance attriters.

As confirmation of relevant populations, the diagram 200 of FIG. 2 shows average masterfile balance over time for all accounts as well as those accounts that subsequently lost balances. The average balance for the balance attriter accounts decreased dramatically after the scoring date, and this balance decrease identifies the balance attrition. While the balance of the overall population stayed relatively constant over time, the balance of the balance attriter population increased throughout the subsequent performance period; balance attriters bring their balances back over time.

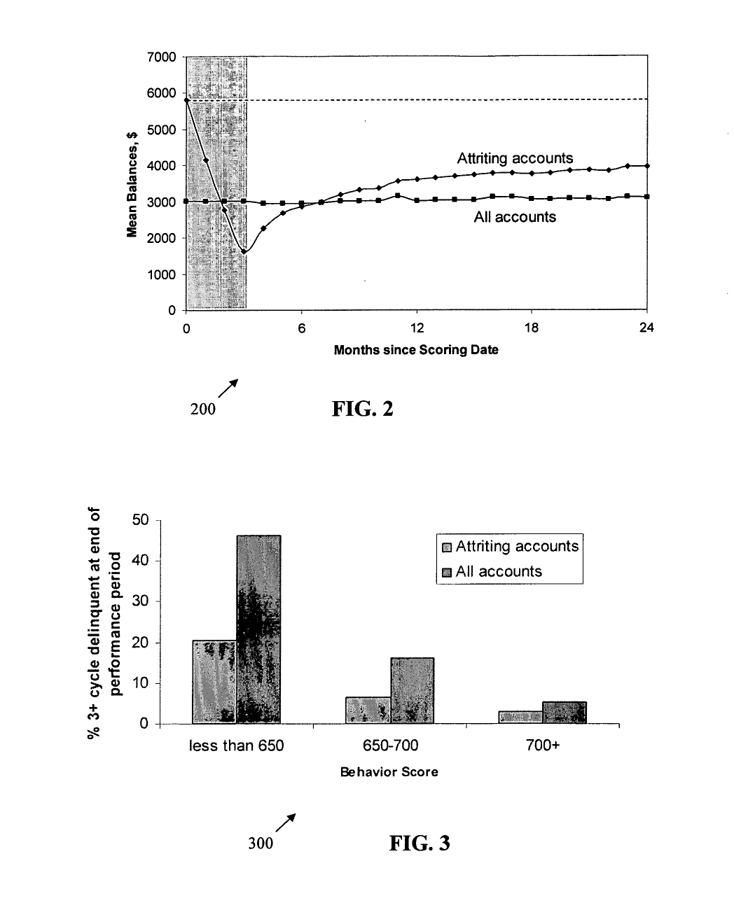

The balance movements may be part of the attriter's active credit management. Indeed, the balance attriter performs better on their payment card than the general population. As savvy consumers, they tend to perform better—on average—than most accounts. The diagram 300 of FIG. 3, for example, illustrates that these balance attriters who move their balance between their accounts generally perform better on those accounts than those who do not.

Although balance attriters perform better in general, subclasses of the balance attriters can be identified, namely, those who do so as fiscally responsible behavior and those who do so in order to survive mounting debt. The first subgroup are those that a lender should embrace and try to either keep on books (i.e., prevent balance attrition) or attempt to bring back into the portfolio after attriting (i.e., “choose to woo”). These are consumers who are likely balance attriting to take advantage of teaser rates or otherwise engaging in credit management to maintain lower interest rates or increased rewards. The second subgroup, the irresponsible balance attriters, are the consumers who are likely moving balances around as a form of survival as they struggle to make payments. They are likely to perform poorly over time and thus lenders might hope the consumer attrites before mounting debt goes bad on the lender's books (i.e., “choose to lose”).

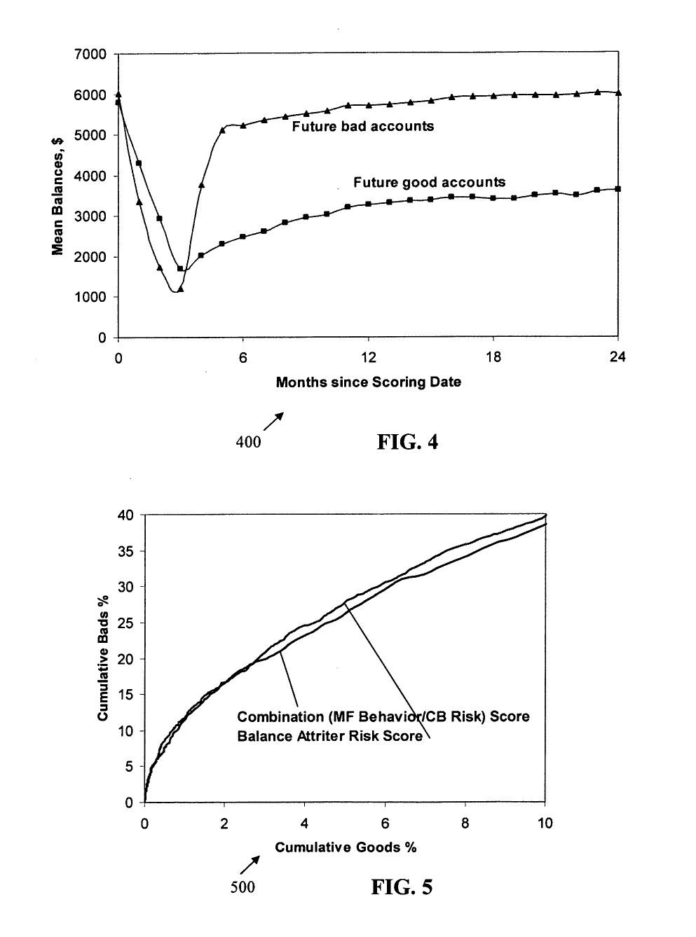

It was determined that those irresponsible balance attriters—those who go on to default—have an immediate and high magnitude increase in balances after the balance attrition event, as seen from diagram 400 of FIG. 4. Those who go on to responsible behavior—those who have a much lower bad rate—have a much smaller and less immediate balance increase.

While subsequent balance change is not actionable at the scoring date, business as usual analytics, including for example, FICO® and Behavior Score (a score based on customer behavior with a single institution including credit limit, number of times the limit was exceeded, spending patterns, etc.), are not specifically tuned to the likelihood of being an irresponsible balance attriter in the future.

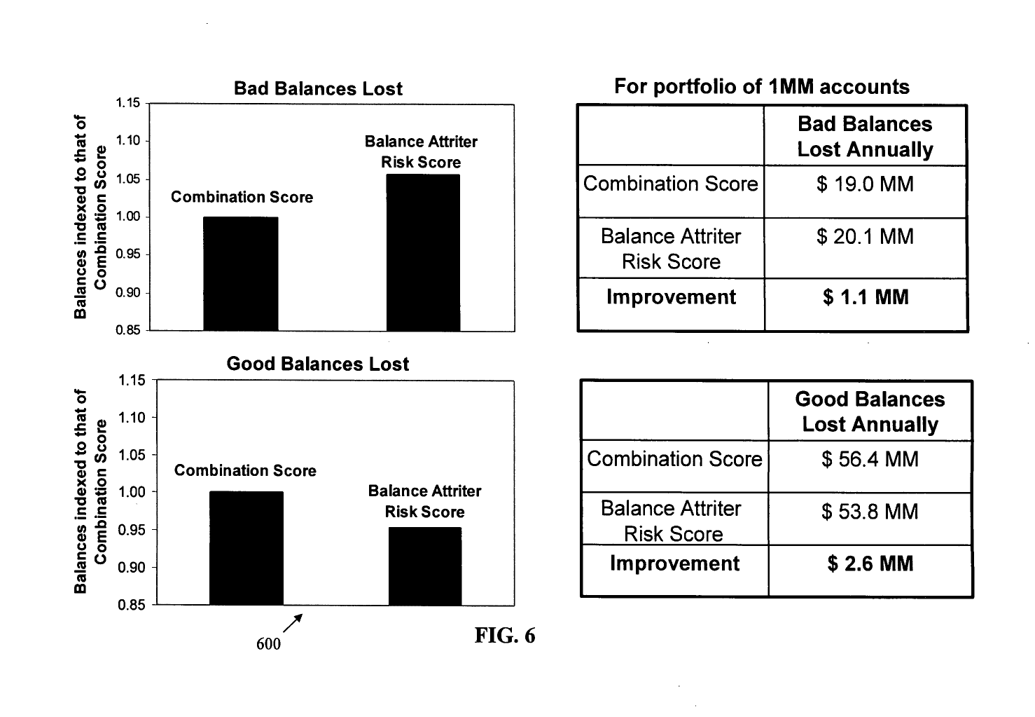

Using Future Action Impact Modeling (FAIM) (see, for example, U.S. patent application Ser. No. 11/832,610, filed on Aug. 1, 2007, the contents of which are hereby fully incorporated by reference) future implications of balance attrition events can be predicted. Using FAIM modeling technology, a Balance Attriter Risk (BAR) Score, based on the balance attriter population, can be used to refine the risk prediction of balance attriting consumers. As illustrated in diagram 500 of FIG. 5, it has been demonstrated that the BAR score outperformed the optimum combination of the MF Behavior Score and CB Risk Score (hereafter referred to as the Combination score) in identifying the worst performing balance attriters, the ones a lender would be wise to choose to lose.

The value of the Balance Attriter Risk Score relative to business as usual approaches can also be evaluated based on financial metrics. The diagram 600 of FIG. 6 quantifies the implications of using such an analytic to lose all attriters below a bottom 10% cutoff (i.e. lose the worst 10% of attriters as indicated by each metric). Using the Balance Attriter Risk Score enables the lender using this strategy to lose 6% more bad balances (corresponding to $1 mM more bad balances for a typical 1 mM account portfolio) and 5% less good balances (corresponding to $2.6 mM).

Similarly, the Balance Attriter Risk Score also outperformed the baseline Combination score at identifying the best attriters, those consumers one would choose to woo. Thus, by differentiating the likely responsibility of the consumers' balance churn behavior following the balance attrition event, the Balance Attriter Risk Score can be used to make more effective decisions about which attriters to lose and which attriters to woo, and provides lenders with the ability to take action to mitigate loss from high-risk attriters, while maximizing revenue from low-risk attriters.

The predictive model used herein to generate the Balance Attriter Risk Score can be based, for example, on a scorecard model developed using FAIM or the ModelBuilder™ software suite of Fair Isaac Corporation. In some implementations, a divergence-based optimization algorithm can be trained using the data obtained from a large number of balance attriters as well as subsequent masterfile (or in some variations, credit bureau) payment delinquencies and corresponding credit scores. In one example, “bad” attriters were characterized as consumers that were delinquent on at least one payment card account for at least three cycles during a pre-defined performance period and “good” attriters were characterized as consumers that were never delinquent for more than one cycle on any of his or her payment card accounts during a relevant performance period. The underlying model may use a variety of predictive technologies, including, for example, neural networks, support vector machines, and the like in order to predict future creditworthiness of a single user based on historical data from a large number of users.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. In addition, it will be appreciated that the subject matter described herein can utilize additional or substitute data sets that represent credit behavior and/or performance. Such datasets include, and are not limited to, credit bureau data, application data, and demographic data. Other embodiments may be within the scope of the following claims.

What is claimed is:

1. An article comprising a machine-readable medium embodying instructions that when performed by one or more machines result in operations comprising:
receiving a request to generate a balance attriter risk score, the balance attriter risk score characterizing a likelihood of a change in a level of creditworthiness of an individual following balance attrition based on a responsibility characterization of post attrition balance behavior of such individual;
estimating future credit balance increases for the individual using a predictive model trained using historical creditworthiness data of a plurality of balance attriters;
associating the estimated future balance increases with a balance attriter risk score; and
initiating provision of the balance attriter risk score.

2. An article as in claim 1, wherein the estimated future credit balance increases are masterfile balance increases.

3. An article as in claim 1, wherein the estimate future credit balance increases are credit bureau balance increases.

4. An article as in claim 1, wherein the balance attriter risk score is provided by displaying the balance attriter risk score.

5. An article as in claim 1, wherein the balance attriter risk score is provided by transmitting the balance attriter risk score over a communications network to a remote user.

6. An article as in claim 1, wherein the predictive model is a scorecard model.

7. A computer-implemented method comprising:
receiving a request to generate a balance attriter risk score, the balance attriter risk score characterizing a likelihood of a change in a level of creditworthiness of an individual following balance attrition;
estimating future credit balance changes for the individual using a predictive model trained using historical creditworthiness data of a plurality of balance attriters;
associating the estimated future balance changes with a balance attriter risk score; and
initiating provision of the balance attriter risk score.

8. A computer-implemented method as in claim 7, wherein the estimated future credit balance changes are masterfile balance increases and decreases.

9. A computer-implemented method as in claim 7, wherein the estimate future credit balance changes are credit bureau balance increases and decreases.

10. A computer-implemented method as in claim 7, wherein the balance attriter risk score is provided by displaying the balance attriter risk score.

11. A computer-implemented method as in claim 7, wherein the balance attriter risk score is provided by transmitting the balance attriter risk score over a communications network to a remote user.

12. A computer-implemented method as in claim 7, wherein the predictive model is a scorecard model.

13. An apparatus comprising:
means for receiving a request to generate a balance attriter risk score, the balance attriter risk score characterizing a likelihood of a change in a level of creditworthiness of an individual following balance attrition;
means for estimating future credit balance increases for the individual using a predictive model trained using historical creditworthiness data of a plurality of balance attriters;
means for associating the estimated future balance increases with a balance attriter risk score; and
means for initiating provision of the balance attriter risk score.

14. An apparatus as in claim 13, wherein the estimated future credit balance increases are masterfile balance increases.

15. An apparatus as in claim 13, wherein the estimate future credit balance increases are credit bureau balance increases.

16. An apparatus as in claim 13, wherein the balance attriter risk score is provided by displaying the balance attriter risk score.

17. An apparatus as in claim 13, wherein the balance attriter risk score is provided by transmitting the balance attriter risk score over a communications network to a remote user.

18. An apparatus as in claim 13, wherein the predictive model is a scorecard model.

19. An article comprising a machine-readable medium embodying instructions that when performed by one or more machines result in operations comprising:
receiving a request to generate a balance attriter risk score in response to a balance attrition event, the balance attriter risk score characterizing a likelihood of a change in a level of creditworthiness of an individual following balance attrition;
estimating future masterfile balance increases for the individual using a predictive model trained using historical creditworthiness data of a plurality of balance attriters derived from masterfile data;
associating the estimated future masterfile balance changes with a balance attriter risk score; and
initiating provision of the balance attriter risk score.

20. An article comprising a machine-readable medium embodying instructions that when performed by one or more machines result in operations comprising:
receiving a request to generate a balance attriter risk score, the balance attriter risk score characterizing a likelihood of an change in a level of creditworthiness of credit line balance attriter;
estimating future payment delinquencies for the credit line balance attriter using a predictive model trained using historical creditworthiness data of a plurality of balance attriters;
associating the estimated future payments delinquencies with a balance attriter risk score; and
initiating provision of the balance attriter risk score.
